(19) United States
(12) Patent Application Publication
(10) Pub. No.: US 2026/0326656 A1
(43) Pub. Date: Oct. 22, 2026

(54) Cargo Restraining Apparatus

(71) Applicant: Conner Harper, Bracey, VA (US)

(72) Inventor: Conner Harper, Bracey, VA (US)

(21) Appl. No.: 19/578,871

(22) Filed: Mar. 26, 2026

Related U.S. Application Data
(60) Provisional application No. 63/904,692, filed on Oct. 24, 2025.

(51) Int. Cl. B60P 7/08

(52) U.S. Cl. CPC B60P 7/0876; B60P 7/083

(57) ABSTRACT

A cargo restraining apparatus includes a rope frame defining a perimeter having length portions and width portions. A plurality of support paracord segments extend across the width of the rope frame between opposing length portions. An internal rope member is disposed within the perimeter and extends between opposing width portions of the rope frame. A plurality of secondary paracord segments extend between the width portions and are disposed between the internal rope member and the length portions of the rope frame. The support paracord segments may intersect and be coupled to the internal rope member, and the secondary paracord segments may intersect and be coupled to the support paracord segments. Straps coupled to portions of the rope frame may extend around a load and couple to an external securing device. Multiple cargo restraining apparatuses may be coupled together to secure a load positioned between the apparatuses.

### CROSS REFERENCE TO RELATED APPLICATIONS

This application claims the benefit of U.S. Provisional Patent Application No. 63/904,692, filed on Oct. 24, 2025, the entire disclosure of which is hereby incorporated by reference in its entirety.

### FIELD OF DISCLOSURE

The present disclosure relates generally to cargo securing devices and more particularly to rope based cargo restraining apparatuses configured to secure loads using braided paracord support structures and strap-coupled restraint systems.

### BACKGROUND

Cargo securing devices are commonly used to stabilize loads during transportation in vehicles, trailers, and cargo containers. Conventional cargo restraint systems often include straps, ropes, nets, or rigid barriers that are positioned around or over a load to prevent movement while the vehicle is in motion. Proper cargo restraint is important for maintaining load stability and reducing the risk of cargo shifting, which can cause damage to the cargo or create unsafe transportation conditions.

In certain industries, large quantities of construction materials are frequently transported on trucks and trailers. For example, composite decking boards and similar elongated construction materials are often transported in stacked configurations. During transport, these boards may shift or slide relative to one another, particularly when only traditional cargo straps are used. In some situations, the center portion of a stacked load may shift outward between straps, causing the straps to loosen and allowing portions of the load to become displaced. Such displacement may result in damaged materials, including road rash or impact damage, which can render the materials unsellable.

Traditional cargo nets and rope-based restraining systems may rely on simple cord grids or elastic netting structures. While such systems may provide basic restraint, many existing cargo nets lack sufficient structural reinforcement to distribute loads across the restraining structure. Under heavy loads or repeated use, conventional cord grids may stretch, loosen, or fail at connection points between cord members. In addition, many commercially available cargo nets are manufactured with stitched textile materials that may not be suitable for restraining rigid or elongated loads such as stacks of decking boards.

In addition, many existing cargo securing devices do not easily adapt to loads of varying shapes and sizes. Some systems rely on single nets or straps that only secure one portion of a load, which may allow movement in other directions. Other systems may require multiple independent straps or complex installation procedures to properly restrain cargo.

Accordingly, there remains a need for improved cargo restraining systems capable of providing reinforced load distribution, improved structural durability, and flexible configurations that allow cargo to be secured more effectively across multiple portions of a load.

### SUMMARY

The present disclosure generally relates to cargo securing systems and more particularly to rope-based cargo restraining apparatuses configured to secure loads using braided paracord support structures and strap-coupled restraint systems.

In one aspect, a cargo restraining apparatus includes a rope frame defining a perimeter having a length and a width. A plurality of support paracord segments extend across the width of the rope frame between opposing length portions of the rope frame. Each support paracord segment may include braided paracord, and in certain embodiments may include multiple strands of paracord arranged into braided sections to provide increased structural integrity and load distribution.

The cargo restraining apparatus may further include at least one internal rope member disposed within the perimeter of the rope frame and extending between opposing width portions of the rope frame. A plurality of secondary paracord segments may extend between the width portions of the rope frame and may be disposed between the internal rope member and the length portions of the rope frame to form a reinforced restraining grid. In certain embodiments, the support paracord segments and the secondary paracord segments may be coupled to one another or to the internal rope member at one or more intersection points using weaving, additional paracord strands, tying, heat-fusing techniques, or combinations thereof.

In some embodiments, straps may be coupled to portions of the rope frame and configured to extend around a load and couple to an external securing device. The straps may allow the cargo restraining apparatus to be secured using devices such as ratchet straps or other tensioning systems. In certain configurations, multiple cargo restraining apparatuses may be coupled together using the straps and an external securing device such that a load is positioned between the apparatuses and secured therebetween.

In some implementations, the support paracord segments may be spaced along the rope frame at defined intervals and may include braided structures formed from multiple strands of paracord. Secondary paracord segments may also include braided structures to further reinforce the restraining grid. The rope frame, support segments, secondary segments, and internal rope members may collectively provide enhanced load distribution and increased load-bearing capacity.

In certain embodiments, the cargo restraining apparatus may be configured to secure loads such that portions of the load including upper, lower, left, and right portions of the load are restrained when multiple cargo restraining apparatuses are used together.

Methods of securing cargo using the cargo restraining apparatuses are also disclosed. In one embodiment, a first cargo restraining apparatus and a second cargo restraining apparatus may be positioned around a load. Straps of the apparatuses may be extended around the load and coupled together using an external securing device such as a ratchet strap so that the load is secured between the apparatuses.

The cargo restraining apparatuses described herein may provide improved load stability, enhanced structural reinforcement, and flexible configurations for securing cargo in transportation and storage environments.

### BRIEF DESCRIPTION OF DRAWINGS

FIG. 1 is a top plan view of a cargo restraining apparatus.

FIG. 2 is a perspective view of the cargo restraining apparatus.

FIG. 3 illustrates two cargo restraining apparatuses coupled together.

FIG. 4 illustrates two cargo restraining apparatuses securing a load positioned between the coupled cargo restraining apparatuses.

FIG. 5 further illustrates two cargo restraining apparatuses securing a load positioned between the coupled cargo restraining apparatuses.

### DETAILED DESCRIPTION

The following detailed description illustrates embodiments of the present disclosure. These embodiments are described in sufficient detail to enable a person of ordinary skill in the art to practice these embodiments without undue experimentation. It should be understood, however, that the embodiments and examples described herein are given by way of illustration only, and not by way of limitation. Various substitutions, modifications, additions, and rearrangements may be made that remain potential applications of the disclosed techniques. Therefore, the description that follows is not to be taken as limiting on the scope of the appended claims. In particular, an element associated with a particular embodiment should not be limited to association with that particular embodiment but should be assumed to be capable of association with any embodiment discussed herein.

Unless otherwise defined, all technical and scientific terms used herein have the same meaning as commonly understood by one of ordinary skill in the art. In case of conflict, the present disclosure, including any definitions provided herein, shall control. The materials, methods, and examples disclosed herein are illustrative only and are not intended to be limiting. Methods and materials similar or equivalent to those described herein can be used in the practice or testing of the disclosed invention. All publications, patent applications, patents, and other references mentioned herein are incorporated by reference in their entirety, to the extent that they do not conflict with the disclosure provided in this document. As used in this application, the terms “comprise(s),” “include(s),” “having,” “has,” “can,” “contain(s),” and variants thereof are intended to be open-ended transitional phrases or terms that do not preclude the presence of additional elements or steps. The singular forms “a,” “an,” and “the” also include plural forms unless the context clearly dictates otherwise. The present disclosure also contemplates embodiments comprising, consisting of, or consisting essentially of the elements or features described herein, whether explicitly set forth or not.

Reference will now be made in detail to embodiments of the present disclosure, examples of which are illustrated in the accompanying drawings. While the invention will be described in conjunction with these embodiments, it will be understood that the invention is not intended to be limited to the embodiments described. Rather, the invention is intended to cover alternatives, modifications, and equivalents that may be included within the spirit and scope of the invention as defined by the appended claims.

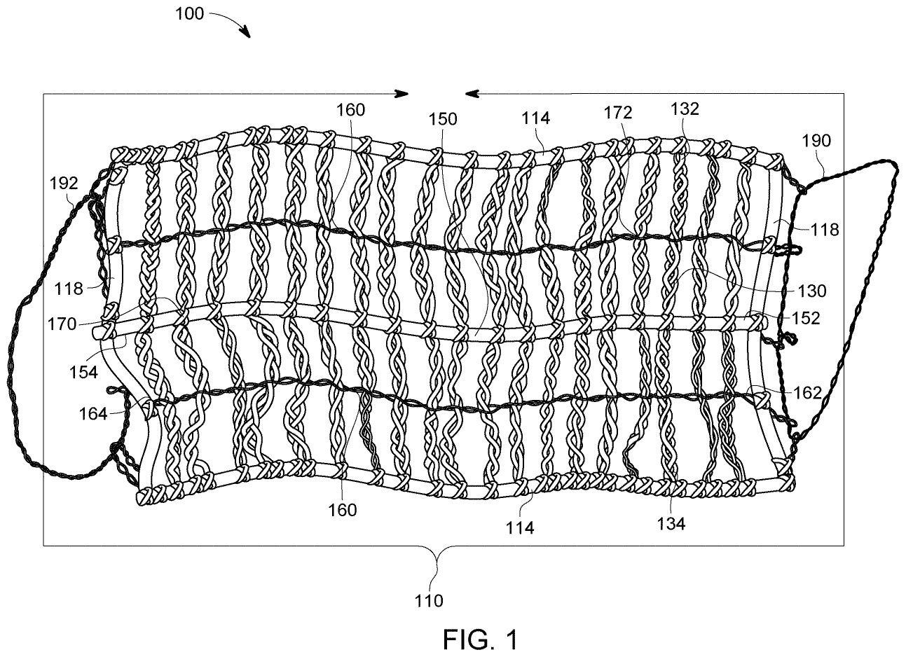

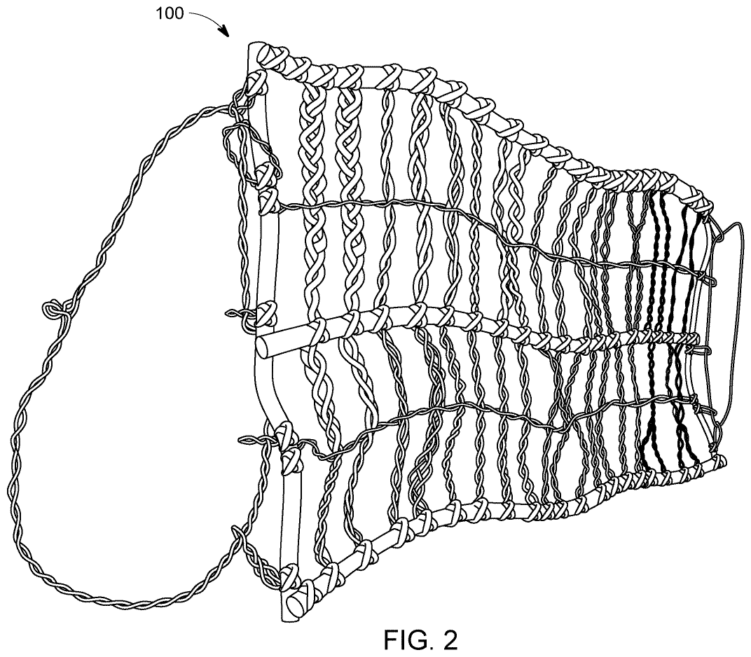

Referring now to FIGS. 1 and 2, a cargo restraining apparatus 100 is illustrated. The cargo restraining apparatus 100 may be configured to restrain, stabilize, or secure a load during transportation or storage. In some embodiments, the cargo restraining apparatus 100 may be used within vehicles, trailers, trucks, cargo containers, or other transportation environments in which loads may shift during movement.

The cargo restraining apparatus 100 has a rope frame 110 defining a perimeter having a length and a width. The rope frame 110 may form an outer structural boundary of the apparatus and may provide structural support for additional restraining components. In some embodiments, the rope frame 110 may include opposing length portions 114 and opposing width portions 118 which collectively define the perimeter of the rope frame 110.

The rope frame 110 may be formed from rope segments joined together to define the perimeter. In some embodiments, the rope frame 110 may comprise nylon rope. In some embodiments, the rope used to form the rope frame 110 may have a thickness of approximately 19 millimeters or greater, although other rope diameters may be used depending on the intended load capacity.

In some embodiments, the rope frame 110 may include length portions measuring approximately 47 inches and width portions measuring approximately 26 inches, although other dimensions may be used. These dimensions may vary depending on the intended cargo application.

As illustrated in FIGS. 1 and 2, a plurality of support paracord segments 130 extend across the width of the rope frame 110 between opposing length portions 114. Each support paracord segment 130 may include a first distal end 132 coupled to a first length portion 114 of the rope frame and a second distal end 134 coupled to an opposing length portion 114 of the rope frame.

In some embodiments, the support paracord segments 130 may be spaced along the length portions 114 of the rope frame 110 at intervals of approximately 2.5 inches, although other spacing intervals may be used depending on the desired strength and flexibility of the restraining structure. In some embodiments, the rope frame 110 may have length portions 114 of approximately 47 inches and width portions 118 of approximately 26 inches, and the plurality of support paracord segments 130 may include approximately 19 support paracord segments spaced along the length portions 114.

In some embodiments, the support paracord segments 130 may comprise braided paracord. For example, the support paracord segments 130 may include a braided support paracord structure formed from multiple individual paracord strands. In some embodiments, each support paracord segment 130 may comprise nine strands of paracord arranged into three sections, with each section including approximately three strands of paracord. The braided support paracord segment 130 may be formed using a three-part braid technique in which the three sections are alternately crossed over one another to form the braided structure. This braided configuration may provide increased tensile strength and load distribution across the restraining apparatus.

The cargo restraining apparatus 100 may further include at least one internal rope member 150 disposed within the perimeter of the rope frame 110. The internal rope member 150 may extend between opposing width portions 118 of the rope frame 110. In some embodiments, the internal rope member 150 may include a first end 152 coupled to a first width portion 118 of the rope frame and a second end 154 coupled to an opposing width portion 118 of the rope frame.

The internal rope member 150 may provide additional structural reinforcement to the cargo restraining apparatus 100 and may help distribute loads applied to the support paracord segments 130. In some embodiments, the internal rope member 150 may comprise nylon rope or other synthetic rope materials.

In some embodiments, a plurality of secondary paracord segments 160 may extend between opposing width portions 118 of the rope frame 110. The secondary paracord segments 160 may be disposed between the internal rope member 150 and the length portions 114 of the rope frame 110. Each secondary paracord segment 160 may include a first end 162 coupled to a first width portion 118 of the rope frame and a second end 164 coupled to an opposing width portion 118 of the rope frame.

In some embodiments, the secondary paracord segments 160 may also comprise braided paracord. For example, each secondary paracord segment 160 may include three strands of paracord braided together, which may be formed using a three-part braid technique, although other braided configurations may be used.

The support paracord segments 130 may intersect the internal rope member 150 at one or more intersection points 170. At these intersection points 170, the support paracord segments 130 may be coupled to the internal rope member 150. In some embodiments, these coupling points may be formed through weaving of the paracord strands, wrapping of additional paracord strands, tying techniques, or other coupling mechanisms.

Similarly, the secondary paracord segments 160 may intersect the support paracord segments 130 at one or more intersection points 172. At these locations, the secondary paracord segments 160 may be coupled to the support paracord segments 130 to form a reinforced grid structure within the rope frame 110.

In some embodiments, coupling between intersecting cord segments may be formed by weaving one cord segment through another and incorporating the woven portion within a braided section of the paracord. In other embodiments, an additional strand of paracord may be wrapped and tied around intersecting cord segments to secure them together, and the tied portion may be heat-fused to further secure the connection.

In some embodiments, paracord segments may be coupled to the rope frame 110 or the internal rope member 150 using a tied coupling portion. The tied coupling portion may be formed by tying a segment of paracord or an additional strand of paracord around adjacent rope members. In some embodiments, the tied portion may be heat fused after tying to secure the connection and reduce fraying of the cord material.

In some embodiments, portions of the rope frame 110 or internal rope member 150 may also be coupled to other rope portions of the apparatus using strands of paracord tied around the rope portions and subsequently heat fused.

Referring again to FIGS. 1 and 2, the cargo restraining apparatus 100 may further include a strap system. In some embodiments, a first strap 190 may be coupled to a first portion of the rope frame 110, and a second strap 192 may be coupled to an opposing portion of the rope frame 110. The straps 190 and 192 may extend outward from the rope frame and may be configured to extend around a load.

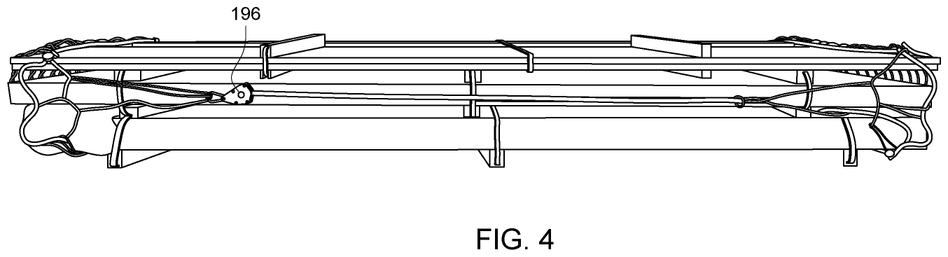

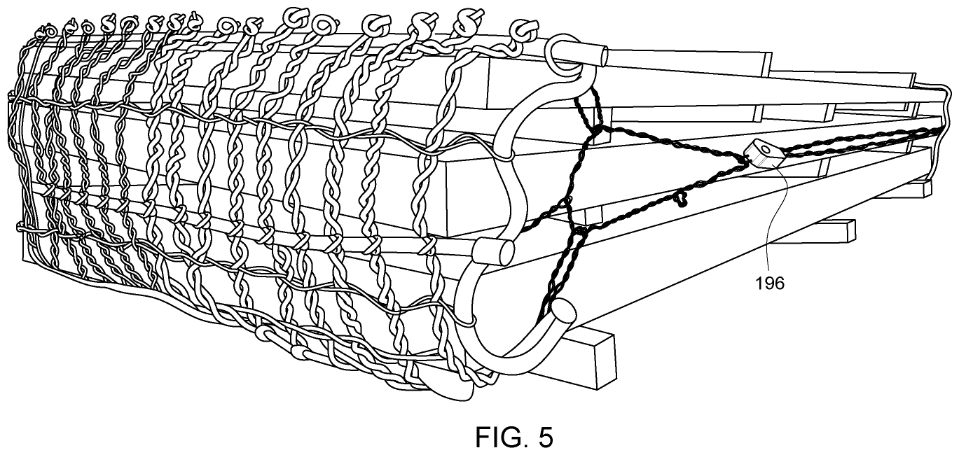

In some embodiments, the straps 190 and 192 may be configured to couple to an external securing device 196, such as a ratchet strap, tensioning strap, buckle system, or other load securing mechanism. As shown in FIGS. 4 and 5, an external securing device 196 may be configured to couple the straps 190 and 192 of the cargo restraining apparatus 100 to straps of a second cargo restraining apparatus, such that a load is positioned between the cargo restraining apparatus 100 and the second cargo restraining apparatus and secured therebetween. The external securing device 196 may be used to apply tension to the straps so that the cargo restraining apparatus 100 may be tightened around the load to stabilize the load during transportation.

In some embodiments, the combination of the rope frame 110, support paracord segments 130, internal rope member 150, and secondary paracord segments 160 may collectively form a reinforced restraining structure capable of supporting substantial loads. For example, in some embodiments, the cargo restraining apparatus 100 may provide a load capacity of approximately 4,000 pounds, although other load capacities may be achieved depending on the materials and dimensions used.

While the embodiments illustrated in FIGS. 1 and 2 show particular configurations of rope members and paracord segments, it will be understood that additional internal rope members, additional paracord segments, or alternative grid arrangements may be used in some embodiments without departing from the scope of the invention.

Accordingly, the cargo restraining apparatus described herein may provide an improved cargo securing system that distributes loads across a reinforced grid structure while allowing flexible installation around loads of various sizes and shapes.

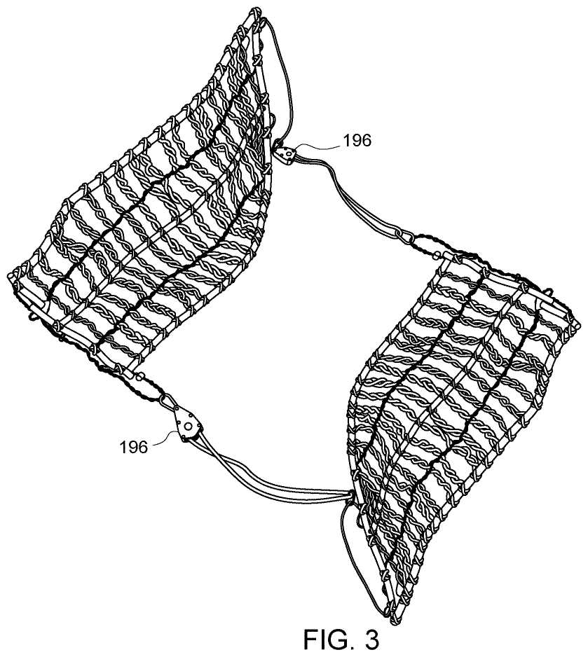

Referring now to FIGS. 3 and 4, additional configurations and methods of using the cargo restraining apparatus 100 are illustrated.

In some embodiments, one or more of the support paracord segments 130 or secondary paracord segments 160 may be coupled to the rope frame 110 or the internal rope member 150 using a tying and heat-fusing technique. For example, a support paracord segment 130 or a secondary paracord segment 160 may be wrapped around a portion of the rope frame 110 or around the internal rope member 150 to form a tied coupling portion. In some embodiments, the tied portion may be formed by knotting the paracord around the rope frame 110, the internal rope member 150, or both. After tying, the paracord may be heated to melt or fuse portions of the cord material, thereby forming a heat-fused region that may prevent loosening of the knot and reduce fraying of the paracord fibers. In some embodiments, the heat-fused portion may be created using a heat source such as a lighter, heated tool, or other thermal device capable of partially melting synthetic paracord material.

In some embodiments, portions of the rope frame 110 or the internal rope member 150 may also be coupled to other rope portions of the apparatus using strands of paracord. For example, a separate strand of paracord may be wrapped around two rope portions and tied to secure the rope portions together. The tied paracord may then be heat fused to further secure the connection. Such coupling techniques may allow rope segments to be secured while maintaining flexibility within the overall structure of the cargo restraining apparatus 100.

In some embodiments, the combined structure of the rope frame 110, the support paracord segments 130, the secondary paracord segments 160, and the internal rope member 150 may collectively provide substantial load-bearing capability. For example, in some embodiments the apparatus 100 may be configured to support loads having a capacity of approximately 4,000 pounds. This load capacity may depend on factors such as rope thickness, paracord strength, braid configuration, spacing of support paracord segments, and the quality of coupling between intersecting cord members.

Referring particularly to FIG. 3, two cargo restraining apparatuses 100 may be positioned adjacent to one another and coupled together using straps. In some embodiments, the first strap 190 and second strap 192 of a first cargo restraining apparatus 100 may be coupled to straps of a second cargo restraining apparatus using an external securing device 196, which may include a ratchet strap, tension strap, buckle system, or other load securing device. The external securing device 196 may apply tension between the straps so that the two cargo restraining apparatuses may be drawn toward one another.

Referring now to FIG. 4 and FIG. 5, two cargo restraining apparatuses 100 may be positioned around a load such that the load is positioned between the two apparatuses. In some embodiments, the straps 190 and 192 of each cargo restraining apparatus may extend around the load and may be coupled together using the external securing device 196. When tension is applied through the external securing device 196, the cargo restraining apparatuses 100 may press against the load and help prevent movement of the load.

In some embodiments, the cargo restraining apparatuses 100 may be positioned such that portions of the apparatus contact or cover multiple sides of the load. For example, the cargo restraining apparatuses may be arranged so that portions of the load including lower, upper, left, and right portions of the load are restrained or partially covered by the cargo restraining apparatuses. Such configurations may improve stability of the load by distributing restraining forces across multiple regions of the load.

In some embodiments, a method of securing a load may include positioning a first cargo restraining apparatus and a second cargo restraining apparatus around opposite ends of the load. Each cargo restraining apparatus may include the rope frame 110, the plurality of support paracord segments 130, the internal rope member 150, and the plurality of secondary paracord segments 160 described above. In some embodiments, the support paracord segments 130 may be spaced along the length portions 114 of the rope frame 110 at intervals of approximately 2.5 inches, and each support paracord segment may comprise a braided configuration including multiple paracord strands. In some embodiments, the paracord used to form the support paracord segments 130 and the secondary paracord segments 160 may comprise 850 paracord.

In some embodiments, the method may further include extending the straps 190 and 192 of the first cargo restraining apparatus and the straps of the second cargo restraining apparatus around the load. The straps may then be coupled together using an external securing device 196, such as a ratchet strap, so that the load is positioned between the first cargo restraining apparatus and the second cargo restraining apparatus.

In some embodiments, the straps 190 and 192 may comprise braided paracord. For example, the straps 190 and 192 may be formed from 850 paracord and may include a braided structure to provide increased strength and durability. In some embodiments, the straps 190 and 192 may be coupled to the rope frame 110 using one or more additional pieces of braided paracord, which may be tied around the straps 190 and 192 and the rope frame 110 to form a coupling. The tied portions may be heat-fused after tying to secure the connection and reduce fraying of the paracord material.

In some embodiments, tension applied by the external securing device 196 may cause the cargo restraining apparatuses to press against the load, thereby restraining the load and limiting movement during transportation. In some embodiments, the structural components of the cargo restraining apparatuses may collectively restrain loads having a capacity of approximately 4,000 pounds.

Although specific embodiments and configurations have been described with reference to FIGS. 3 and 4, it will be understood that various modifications may be made. For example, additional cargo restraining apparatuses may be used, alternative strap configurations may be implemented, or different securing devices may be used to couple the apparatuses together. Such modifications may be made without departing from the scope of the present invention.

What is claimed is:

1. A cargo restraining apparatus comprising:
a rope frame defining a perimeter having a length and a width;
a plurality of support paracord segments extending across the width of the rope frame between opposing length portions of the rope frame, each support paracord segment having a first distal end coupled to a first length portion of the rope frame and a second distal end coupled to an opposing length portion of the rope frame;
at least one internal rope member disposed within the perimeter of the rope frame and extending between opposing width portions of the rope frame, the internal rope member having a first end coupled to a first width portion of the rope frame and a second end coupled to an opposing width portion of the rope frame;
a plurality of secondary paracord segments extending between opposing width portions of the rope frame and disposed between the internal rope member and the length portions of the rope frame such that the secondary paracord segments intersect the support paracord segments to form a reinforced grid structure, each secondary paracord segment having a first end coupled to a first width portion of the rope frame and a second end coupled to an opposing width portion of the rope frame;
a first strap coupled to a first portion of the rope frame and a second strap coupled to an opposing portion of the rope frame, the first strap and the second strap being configured to extend around a load and couple to an external securing device;
wherein the plurality of support paracord segments are coupled to the internal rope member at one or more points of intersection between the support paracord segments and the internal rope member; and
wherein the secondary paracord segments are coupled to the support paracord segments at one or more points of intersection between the secondary paracord segments and the support paracord segments.

2. The cargo restraining apparatus of claim 1, wherein each support paracord segment comprises braided paracord.

3. The cargo restraining apparatus of claim 1, wherein each support paracord segment comprises at least nine strands of paracord arranged into three braided sections, each braided section comprising three strands.

4. The cargo restraining apparatus of claim 2, wherein each secondary paracord segment comprises braided paracord.

5. The cargo restraining apparatus of claim 4, wherein each secondary paracord segment comprises three strands of paracord braided together.

6. The cargo restraining apparatus of claim 1, wherein the support paracord segments and the secondary paracord segments comprise 850 paracord.

7. The cargo restraining apparatus of claim 1, wherein the rope frame and the internal rope member comprise nylon.

8. The cargo restraining apparatus of claim 1, wherein the rope frame comprises a rope having a thickness of about 19 millimeters or greater.

9. The cargo restraining apparatus of claim 1, wherein the support paracord segments are spaced along the length portions of the rope frame at intervals of about 2.5 inches.

10. The cargo restraining apparatus of claim 1, wherein the rope frame comprises length portions of about 47 inches and width portions of about 26 inches, and wherein the plurality of support paracord segments comprises 19 support paracord segments.

11. The cargo restraining apparatus of claim 1, wherein the support paracord segments and the secondary paracord segments are coupled at the points of intersection by weaving one segment through another and incorporating the woven portion within a braided section of the paracord.

12. The cargo restraining apparatus of claim 1, wherein the internal rope member and the support paracord segments are coupled at the points of intersection by an additional strand of paracord wrapped around both the internal rope member and the support paracord segments.

13. The cargo restraining apparatus of claim 1, wherein at least one of the support paracord segments or the secondary paracord segments is coupled to the rope frame or the internal rope member by tying the paracord segment or an additional strand of paracord around the rope frame or the internal rope member and heat fusing the tied portion.

14. The cargo restraining apparatus of claim 1, wherein at least one portion of the rope frame or the internal rope member is coupled to another rope portion of the apparatus by a strand of paracord tied around the rope portions and heat fused.

15. The cargo restraining apparatus of claim 1, wherein the rope frame, the support paracord segments, the secondary paracord segments, and the internal rope member collectively provide a load capacity of about 4,000 pounds.

16. The cargo restraining apparatus of claim 1, wherein the first strap and the second strap are configured to couple the cargo restraining apparatus to a second cargo restraining apparatus using a ratchet strap or other external securing device such that a load is positioned between the cargo restraining apparatus and the second cargo restraining apparatus and secured therebetween.

17. The cargo restraining apparatus of claim 16, wherein the cargo restraining apparatus and the second cargo restraining apparatus are configured to secure the load such that portions of the load including a lower portion, an upper portion, a left portion, and a right portion of the load are covered by the cargo restraining apparatus and the second cargo restraining apparatus.

18. A method of securing a load using cargo restraining apparatuses, the method comprising:
positioning a first cargo restraining apparatus and a second cargo restraining apparatus around a load, each cargo restraining apparatus comprising a rope frame defining a perimeter, a plurality of support paracord segments spaced along length portions of the rope frame at intervals of about 2.5 inches, each support paracord segment comprising at least nine strands of paracord arranged into three braided sections, an internal rope member, and a plurality of secondary paracord segments each comprising three strands of paracord braided together;
extending straps of the first cargo restraining apparatus and straps of the second cargo restraining apparatus around the load; and
coupling the straps of the first cargo restraining apparatus to the straps of the second cargo restraining apparatus using a ratchet strap or other external securing device such that the load is positioned between the first cargo restraining apparatus and the second cargo restraining apparatus and secured therebetween.

19. The method of claim 18, further comprising positioning the first cargo restraining apparatus and the second cargo restraining apparatus such that portions of the load including a lower portion, an upper portion, a left portion, and a right portion of the load are covered by the first cargo restraining apparatus and the second cargo restraining apparatus.

20. The method of claim 18, wherein the first cargo restraining apparatus and the second cargo restraining apparatus collectively secure the load such that the load is restrained with a load capacity of about 4,000 pounds.
